(19) United States
(12) Patent Application Publication
(10) Pub. No.: US 2008/0170111 A1
(43) Pub. Date: Jul. 17, 2008

(54) INK JET PRINTER

(75) Inventors: Toshiyuki SUZUKI, Shiojiri-shi (JP); Kunio TABATA, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/970,023

(22) Filed: Jan. 7, 2008

(30) Foreign Application Priority Data
Jan. 12, 2007 (JP) 2007-004091

(51) Int. Cl. B41J 2/01

(52) U.S. Cl. 347/104

(57) ABSTRACT

There is provided an ink jet printer including: a plurality of rollers; a transporting belt wound on the plurality of rollers; ink jet heads which discharge ink droplets onto a printing medium transported by the transporting belt; a calibrator which matches eccentric phases of the plurality of roller to each other; and a calibration control unit which matches the eccentric phases of the rollers to each other by the calibrator if the numbers of rotations of the rollers become a predetermined calibration rotation number.

### BACKGROUND

1. Technical Field

The present invention relates to an ink jet printer for discharging minute liquid ink droplets of a plurality of colors from a plurality of nozzles and forming minute particles (ink dots) on a printing medium so as to form a predetermined character or image.

2. Related Art

Since an ink jet printer can easily obtain a multi-color printed material having high quality with low cost, the ink jet printer has come into wide use among general users as well as offices as a personal computer or a digital camera has come into wide use.

In general, the ink jet printer discharges (ejects) liquid ink droplets from nozzles of printing heads and forms minute ink dots on a printing medium while a movable body called a cartridge including ink cartridges and the printing heads (also called ink jet heads), both of which are integrally provided, reciprocally moves on the printing medium in a direction crossing a transporting direction of the printing medium such that a predetermined character or image is formed on the printing medium so as to obtain a desired printed material. The cartridge includes ink cartridges of four colors (yellow, magenta and cyan) including black and the printing heads of the respective colors such that full-color printing as well as monochromic printing is possible (six colors, seven colors or eight colors including light cyan, light magenta or the like in addition to the above-described colors have been put to practical use).

In an ink jet printer for performing printing while the ink jet heads on the cartridge reciprocally move in the direction crossing the transporting direction of the printing medium, the ink jet heads need to reciprocally move ten times to several ten times in order to clearly print one page. In contrast, in an ink jet printer in which ink jet heads (which do not need to be integrally formed) each having the same length as the width of the printing medium are arranged and cartridges are not used, the ink jet heads do not need to move in a width direction of the printing medium and one-pass printing is possible, thereby realizing high-speed printing. The former ink jet printer is generally called a “multi-pass (serial) ink jet printer” and the latter ink jet printer is generally called a “line head type ink jet printer. In particular, a line head type ink jet printer in which a transporting belt is stretched between a driving roller and a driven roller and high-speed printing is performed while the printing medium is transported by the transporting belt so as to shorten a time consumed for printing one page of a printing medium was suggested.

In order to perform high-quality printing using the ink jet printer, ink droplet need to be accurately discharged (impact) to a target position of the printing medium. In particular, when the ink droplets are discharged while the printing medium in the line head type ink jet printer, adaptability between a state of transporting the printing medium by the transporting belt and a timing of discharging the ink droplets is of importance. Accordingly, the transporting belt and the printing medium or a roller on which the transporting belt is wound, the transporting belt and the printing medium move in synchronization with each other. For example, in an ink jet printer disclosed in JP-A-11-170623, ink droplets are discharged from ink jet heads in synchronization with an input pulse from a rotary encoder provided in a driving roller. For example, in an ink jet printer disclosed in JP-A-11-245383, ink droplets are discharged from ink jet heads in synchronization with an input pulse from a linear encoder provided on a transporting belt.

However, since at least two rollers are used in the transportation of the printing medium by the transporting belt, the distance between the rollers varies according to eccentric phases of the rollers. If the distance between the rollers varies, expansion and contraction occurs in the transporting roller wound on the rollers and periodic unevenness occurs between the movement amount of the transporting roller and the movement amount of the printing medium due to the expansion and contraction. Thus, visible unevenness occurs in the printed image. The eccentricity of the roller cannot be avoided. However, if the diameter of the roller is increased such that the unevenness period becomes at least the length of the printed image, the unevenness which occurs in the printed image does not become visible. However, if the diameter of the roller is increased, the size of the apparatus is increased.

### SUMMARY

An advantage of some aspects of the invention is that it provides an ink jet printer capable of preventing unevenness from occurring in a printed image due to eccentricities of rollers on which a transporting roller is wound.

According to an aspect of the invention, there is provided an ink jet printer including: a pair of rollers; a transporting belt wound on the pair of rollers; ink jet heads which discharge ink droplets onto a printing medium transported by the transporting belt; a calibrator which matches eccentric phases of the pair of rollers to each other; and a calibration control unit which matches the eccentric phases of the rollers to each other by the calibrator if the numbers of rotations of the rollers become a predetermined calibration rotation number.

The present inventors developed the invention by studying a method of preventing unevenness of a printed image by eccentricities of rollers on which the transporting roller is wound. That is, since the distance between the rollers is changed and the transporting belt expands and contracts, the unevenness of the printed image due to the eccentricities of the rollers. The eccentricities of the rollers cannot be actually avoided. However, if the eccentric directions of the rollers are set to the same direction, that is, if the eccentric phases of the rollers are matched to each other, the distance between the rollers is not changed and the transporting belt does not expand and contract. Meanwhile, although the eccentric phases of the rollers are matched to each other, if the rollers are rotated, a phase difference may occur due to a difference between the circumferential lengths of the rollers due to roller machining precision. For example, the matching of the eccentric phases of the rollers at the time of printing one page of a printing medium is not suitable for the high-speed printing of a line head type ink jet printer. When the predetermined calibration rotation number is set such that the maximum variation in distance between the two rollers is equal to or less than the predetermined value and the eccentric phases of the two rollers are matched to each other if the numbers of rotations of the rollers become the predetermined calibration rotation number, it is possible to simultaneously realize the high-speed printing and the prevention of the unevenness of the printed image. In the invention, the number of rotations is the number of times of rotation and is not a rotation speed which is generally recognized.

According to this configuration, in the ink jet printer in which the transporting belt is wound on the at least two rollers and the ink droplets are discharged from the ink jet heads onto the printing medium transported by the transporting belt, if the number of rotations of the rollers becomes the predetermined calibration rotation number, the eccentric phases of the rollers is matched to each other. Accordingly, it is possible to simultaneously realize the high-speed printing and the prevention of the unevenness of the printed image.

In the ink jet printer, the predetermined calibration rotation number may be set such that a maximum variation in distance between the rollers is equal to or less than a predetermined value.

According to this configuration, since the predetermined calibration rotation number is set such that the maximum variation in distance between the rollers is equal to or less than the predetermined value, it is possible to prevent unevenness of a printed image with certainty.

The ink jet printer may further include reference phase detection units which respectively detect reference phases of the rollers, and the calibration control unit sets reference phases of the rollers detected by the reference phase detection units to predetermined phases if the reference phases of the rollers are matched to the phases corresponding to eccentric directions of the rollers.

According to this configuration, since the detected reference phases of the rollers are set to the predetermined phases if the reference phases of the rollers are matched to the phases corresponding to eccentric directions of the rollers, it is possible to match the eccentric phases of the rollers to each other with certainty.

In the ink jet printer, the calibration control unit previously may store a phase difference between the reference phases of the rollers and the phases corresponding to the eccentric direction of the rollers, set the reference phases of the rollers detected by the reference phase detection units to predetermined phases, and rotate the rollers by the phase difference so as to match the eccentric phases of the roller to each other, if the reference phases of the rollers are not matched to the phases corresponding to eccentric directions of the rollers.

According to this configuration, since the phase difference between the reference phases of the rollers and the phases corresponding to the eccentric direction of the rollers are previously stored, the reference phases of the rollers detected by the reference phase detection units are set to predetermined phases, and the rollers are rotated by the phase difference so as to match the eccentric phases of the roller to each other if the reference phases of the rollers are not matched to the phases corresponding to eccentric directions of the rollers, it is possible to match the eccentric phases of the rollers to each other with certainty.

In the ink jet printer, if any one of the rollers is a driving roller, the calibration control unit may control rotation by the phase difference by the number of steps of a step motor for driving the driving roller.

According to this configuration, since the rotation by the phase difference is controlled by the number of steps of the step motor for driving the driving roller, it is possible to easily control the rotation by the phase difference of the driving roller 23 with certainty.

In the ink jet printer, if any one of the rollers is a driven roller, the calibration control unit may control rotation by the phase difference by the number of input pulses of a rotary encoder provided in the driven roller.

According to this configuration, since the rotation by the phase difference is controlled by the number of input pulses of the rotary encoder provided in the driven roller if any one of the rollers is the driven roller, it is possible to easily control the rotation by the phase difference of the driven roller with certainty.

The ink jet printer may further include a belt tension removing unit which independently adjusting the phases of the rollers.

According to this configuration, since the ink jet printer includes the belt tension removing unit which independently adjusting the phases of the rollers, it is possible to easily match the eccentric phases of the rollers.

The ink jet printer may further include a friction unit which restricts rotation of a driven roller, if any one of the rollers is the driven roller.

According to this configuration, since the ink jet printer further includes the friction unit which restricts rotation of a driven roller if any one of the rollers is the driven roller, the phase of the driving roller is controlled in a state in which the rotation of the driven roller is restricted by the friction device such that the eccentric phases of the rollers are easily matched to each other.

### BRIEF DESCRIPTION OF THE DRAWINGS

The invention will be described with reference to the accompanying drawings, wherein like numbers reference like elements.

FIG. 1 is a front view showing an ink jet printer according to a first embodiment of the invention.

FIG. 2 is a plan view of the ink jet printer shown in FIG. 1.

FIG. 3 is a detailed view of a rotary encoder attached to a driven roller shown in FIG. 1.

FIG. 4 is a detailed view of a reference phase detection sensor provided in a driving roller and a driven roller shown in FIG. 1.

FIG. 5 is a view showing a reference phase signal from the reference phase detection sensor shown in FIG. 4.

FIGS. 6A, 6B and 6C are views showing a variation in distance between rollers due to a difference in eccentric phase between the driving roller and the driven roller.

FIG. 7 is a view showing a relationship among an eccentric amount of the driving roller, an eccentric amount of the driven roller and the variation in distance between the rollers.

FIGS. 8A and 8B are views illustrating a method of detecting the eccentric amount of the driving roller and the eccentric amount of the driven roller.

FIGS. 9A and 9B are views showing the eccentric amount of the driving roller and the eccentric amount of the driven roller detected by the detecting method of FIGS. 8A and 8B.

FIGS. 10A and 10B are views showing a case where the eccentric amounts of the driving roller and the driven roller are deviated from the reference phase signal.

FIG. 11 is a flowchart showing a computing process of matching the eccentric phases of the driving roller and the driven roller to each other.

FIG. 12 is a flowchart showing a subroutine performed in the computing process shown in FIG. 11.

FIGS. 13A and 13B are views showing a case where the eccentric amounts of the driving roller and the driven roller are not deviated from the reference phase signal.

FIG. 14 is a flowchart of a subroutine performed in the computing process shown in FIG. 11.

### DESCRIPTION OF EXEMPLARY EMBODIMENTS

Next, an ink jet printer according to an embodiment of the invention will be described with reference to the accompanying drawings.

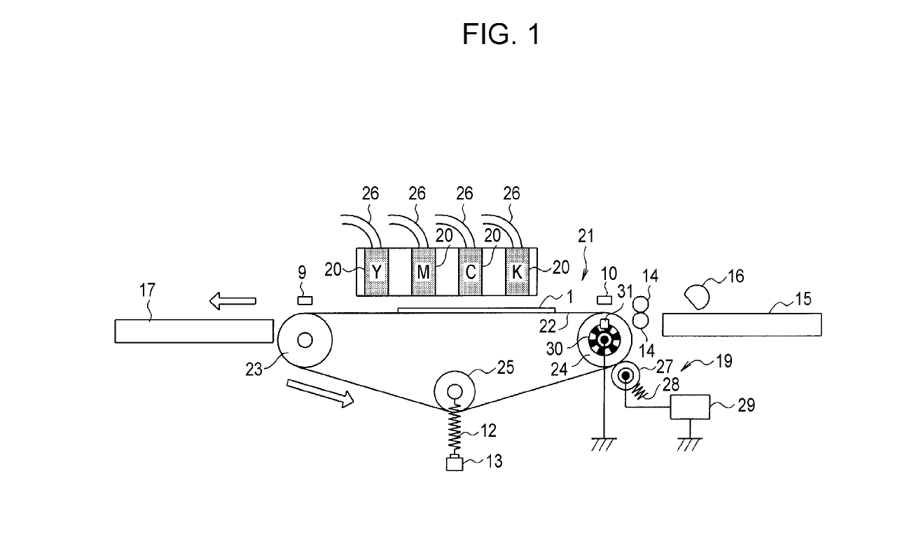

FIG. 1 is a schematic front view showing the configuration of an ink jet printer according to a first embodiment of the invention. FIG. 1 shows a line head type ink jet printer in which a printing medium 1 is transported from the right side of the drawing to the left side thereof as denoted by an arrow and printing is performed in a printing region while transporting the printing medium.

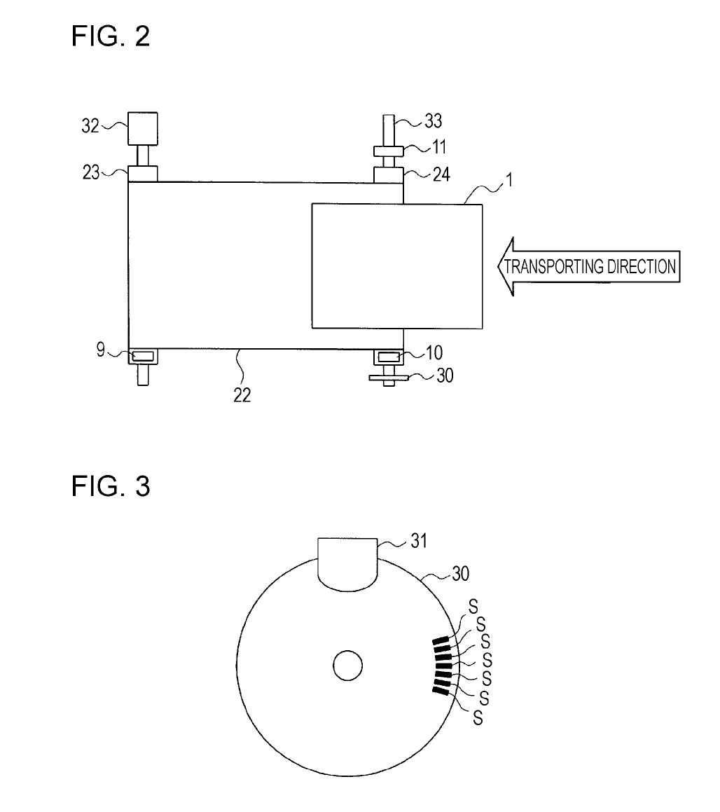

A reference numeral 20 denotes ink jet heads provided in a transporting direction of the printing medium 1. A transporting unit 21 for transporting the printing medium 1 is provided below the ink jet heads 20. The transporting unit 21 includes a transporting belt 22. This transporting belt 22 is wound and stretched on a driving roller 23 arranged at the downstream side of the printing medium transporting direction, a driven roller 24 arranged at the upstream side of the printing medium transporting direction, and a tension roller 25 provided at the lower side of the ink jet heads 20. As shown in FIG. 2, a driving motor 32 is connected to the driving roller 23. A clutch (friction element) 11 for fastening or unfastening the driven roller 24 to a fastening shaft 33 is attached to the driven roller 23. The tension roller 25 is biased to the lower side by a spring 12 and tension is applied to the transporting belt 22 by the bias force. A solenoid 13 for applying/releasing the bias force to the tension roller 25 by the spring 12, that is, the tension to the transporting belt 22, is connected to a lower end of the spring 12. If the solenoid 13 is turned on, the tension is applied to the transporting belt 11 by the spring 12 and, if the solenoid 13 is turned off, the tension to the transporting belt 22 by the spring 12 is released. A direction crossing the printing medium transporting direction is called a nozzle row direction. The driving motor 32 is a so-called step motor. In the present embodiment, the number of steps by a pulse input is set to 1440 such that the driving roller 23 makes one revolution.

As shown in FIG. 2, a rotary encoder disc 30 for detecting a rotation state of the driven roller 24 is attached to a rotation shaft of the driven roller 2 and a rotary encoder sensor 31 for outputting encoder pulses according to the rotation state of the rotary encoder disc 30 is provided above the rotary encoder disc 30. As shown in FIG. 3, slits S are formed in the rotary encoder disc 30 with a pitch corresponding to printer resolution of, for example, 720 dpi, or a pitch of one of the integer number thereof when converting into the movement amount of the transporting belt 22, that is, the movement amount of the printing medium 1. For example, whenever the light emitted from the rotary encoder sensor 31 passes through the slits S, the encoder pulses are output. Accordingly, if the ink droplets are discharged from the ink jet heads 20 in accordance with the encoder pulses having a period corresponding to the printer resolution or one of the integer number thereof (every integer pulse number if the period is one of the integer number of the resolution), the printing can be performed with desired resolution.

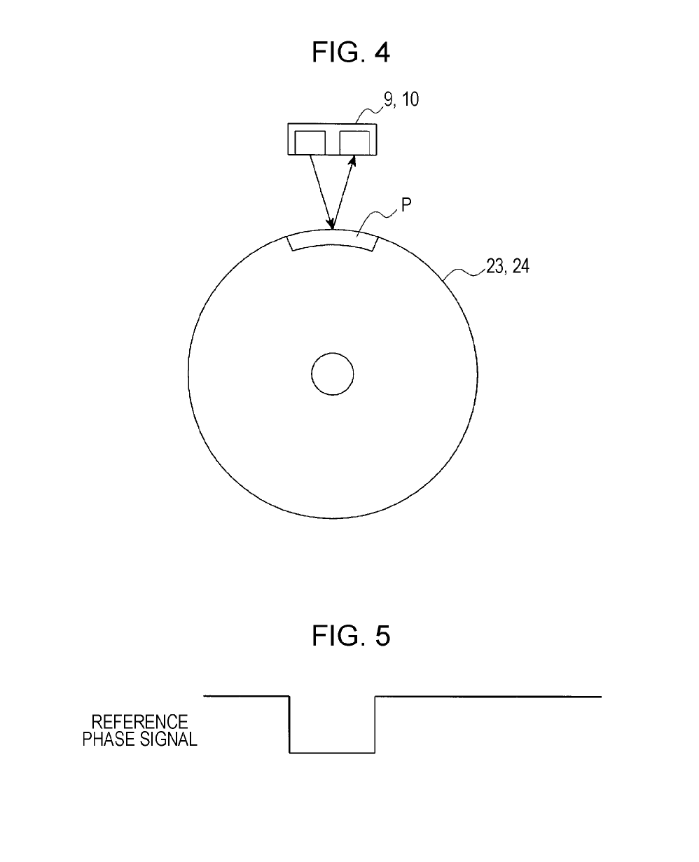

Reference phase detection sensors 9 and 10 for detecting the respective references of the driving roller 23 and the driven roller 24 are respectively provided above the driving roller 23 and the driven roller 24 as shown in FIG. 1. As shown in FIG. 4, the reference phase detection sensors 9 and 10 irradiate lights onto reflection patterns P formed in portions of outer circumferential surfaces of the driving roller 23 and the driven roller 24, detect the reflected lights, and detect the reference phases of the rollers 23 and 24. If the rollers 23 and 24 are rotated at a constant speed, for example, as shown in FIG. 5, the reference phase pulses are output (the down direction of the drawing) while the reflected lights from the reflection patterns P are detected. Accordingly, if the reference phase pulses are detected, it can be seen that the driving roller 23 and the driven roller 24 have the respective reference phases, that is, the phases in which the reflection patterns P are positioned at the upper side thereof.

The ink jet heads 20 are arranged in the transporting direction of the printing medium 1 in order of, for example, yellow (Y), magenta (M), cyan (C) and black (K). Respective inks are supplied from ink tanks (not shown) of respective colors to the ink jet heads 20 through ink supplying tubes 26. A plurality of nozzles are formed in the respective ink jet heads 20 in the direction crossing the transporting direction of the printing medium 1 (that is, the nozzle row direction). Required amounts of ink droplets are simultaneously discharged from the nozzles to required positions such that minute ink dots are formed on the printing medium 1 and are output. This operation is performed with respect to every color and so-called one-pass printing can be performed by passing through the printing medium 1 transported by the transporting unit 21. That is, the arrangement regions of the ink jet heads 20 correspond to a printing region.

Examples of a method of discharging and outputting the inks of the nozzles of the ink jet heads includes an electrostatic method, a piezoelectric method, and a film boiling ink jet method. In the electrostatic method, if a driving signal is applied to an electrostatic gap which is an actuator, a vibration plate in a cavity is displaced so as to cause a variation in pressure in the cavity and the ink droplets are discharged from the nozzles by the variation in pressure. In the piezoelectric method, if a driving signal is applied to a piezoelectric device which is an actuator, a vibration plate in a cavity is displaced so as to cause a variation in pressure in the cavity and the ink droplets are discharged from the nozzles by the variation in pressure. In the film boiling ink jet method, a minute heater is provided in a cavity, the inks are instantly heated to 300° C. or more so as to become a film boiling state, bubbles are generated, and the ink droplets are discharged from the nozzles by the variation in pressure.

A pair of gate roller 14 for correcting the skew of the printing medium 1 and adjusting a timing of feeding the printing medium 1 from a feeding unit 15 is provided at the upstream side of the driving roller 23. The skew is torsion of the printing medium 1 in the transporting direction. A pickup roller 16 for feeding the printing medium 1 is provided above the feeding unit 15. An ejection unit 17 is provided at the downstream side of the printing medium transporting direction of the driven roller 24.

A belt charging device 19 is provided below the driving roller 23. The belt charging device 19 includes a charging roller 27 which is in contact with the transporting belt 22 with the driving roller 23 interposed therebetween, a spring 28 for pressing the charging roller 27 to the transporting belt 22, and a power supply 29 for applying charges to the charging roller 27. The charges are applied from the charging roller 27 to the transporting belt 22 so as to charge the transporting belt. In general, the belt is formed of a middle/high resistance material or an insulating material. Accordingly, if the belt is charged by the belt charging device 19, charges applied to the surface thereof cause dielectric polarization in the printing medium 1 formed of a high resistance material or an insulating material such that the printing medium 1 can be adsorbed to the belt by electrostatic force between the charges generated by the dielectric polarization and the charges of the surface of the belt. As the charging device, so-called corotron for decreasing the charges may be used.

Accordingly, according to this ink jet printer, the surface of the transporting belt 22 is charged by the belt charging device 19, the printing medium 1 is fed from the gate rollers 14 in this state, and the printing medium 1 is pressed against the transporting belt 22 by a sheet pressing roller composed of a roller or a spur (not shown), such that the printing medium 1 is adsorbed to the surface of the transporting belt 22 by the dielectric polarization. In this state, when the driving roller 23 is rotated by the driving motor 32, rotation force is delivered to the driven roller 24 through the transporting belt 22.

The transporting belt 22 to which the printing medium 1 is adsorbed is moved to the downstream side of the transporting direction, the printing medium 1 is moved to the lower side of the ink jet heads 20, and the ink droplets are discharged from the nozzles formed in the ink jet heads 20, thereby performing the printing. If the printing using the ink jet heads 20 is completed, the printing medium 1 is moved to the downstream side of the transporting direction and is ejected by the ejection unit 17.

In the ink jet printer, a control device for controlling the ink jet printer is provided. This control device performs the printing operation with respect to the printing medium by controlling a printing device or a feeding device on the basis of printing data received from a host computer such as a personal computer or a digital camera. For example, when a printing reference signal is supplied from the control device on the basis of the encoder pulses from the rotary encoder sensor (strictly speaking, when a driving pulse is applied after that), the ink droplets are discharged from the nozzles of the ink jet heads 20. The control device is composed of an independent computer system.

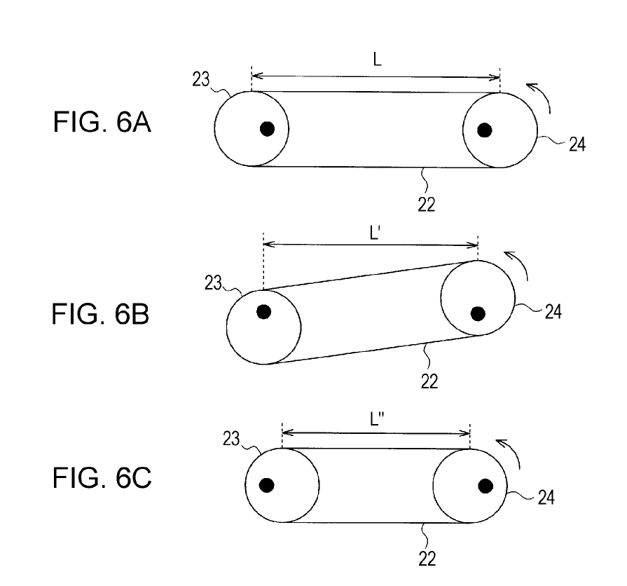

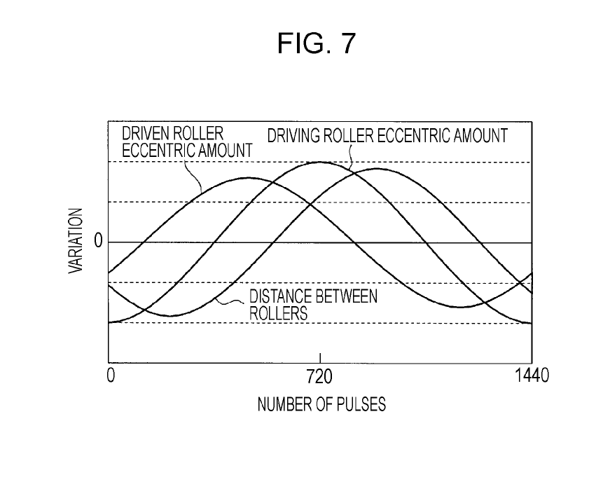

In the ink jet printer according to the present embodiment, the eccentric phase of the driving roller 23 is matched to that of the driven roller 24. The matching of the eccentric phases of the rollers indicates that the eccentric directions of the two rollers are equal to each other. FIG. 6 shows a case the eccentric phase of the driving roller 23 is deviated from the eccentric phase of the driven roller 24 by 180°. As can be seen from FIG. 6, as the driving roller 23 and the driven roller 24 rotate, a distance L between the rollers is changed to L′ and L′. When the distance between the rollers is changed, the expansion and contraction occur in the transporting belt 22 such that the impact positions of the ink droplets discharged from the nozzles of the ink jet heads 20 are displaced. Accordingly, unevenness occurs in a printed image as described above. FIG. 7 is a view tracing the eccentric amount of the driving roller 23 and the eccentric amount of the driven roller, and the distance between the rollers by the number of encoder pulses. In the present embodiment, 1440 encoder pulses are output (that is, the number of encoder pulses is the number of steps of the driving motor 32) while the driven roller 24 makes one revolution.

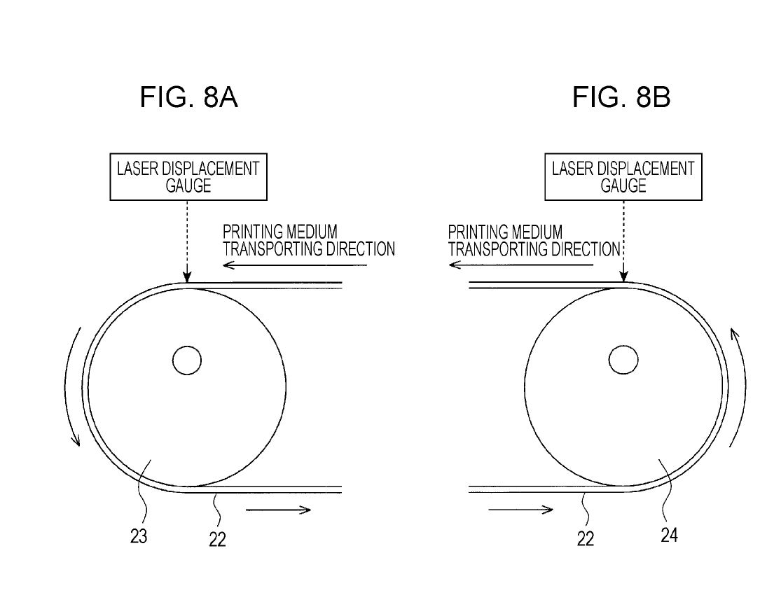

The eccentric direction of the driving roller 23 and the eccentric direction of the driven roller 24 are obtained by detecting the respective eccentric amount. FIG. 8A shows a state in which the eccentric amount of the driving roller 23 is detected by a laser displacement gauge and FIG. 8B shows a state in which the eccentric amount of the driven roller 24 is detected by a laser displacement gauge. The eccentric amount of the driving roller 23 is detected and stored in association with the number of motor steps of the driving motor 32, by rotating the transporting belt 22 by the driving roller 23 and using a reference phase pulse from the reference phase detection sensor 9 for the driving roller as a reference. In contrast, the eccentric amount of the driven roller 24 is detected and stored in association with the number of encoder pulses from the rotary encoder sensor 31, by rotating the driven roller 24 by the transporting belt 22 and using the reference phase detection sensor 10 for the driven roller as a reference. The detection of the eccentric amounts, that is, the detection of the eccentric directions, of the driving roller 23 and the driven roller 24 is performed before shipment of a product or is periodically performed.

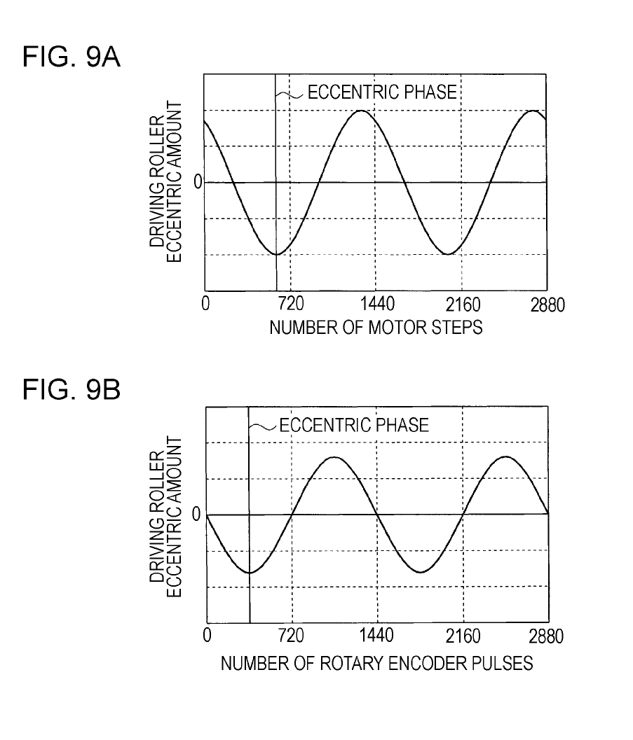

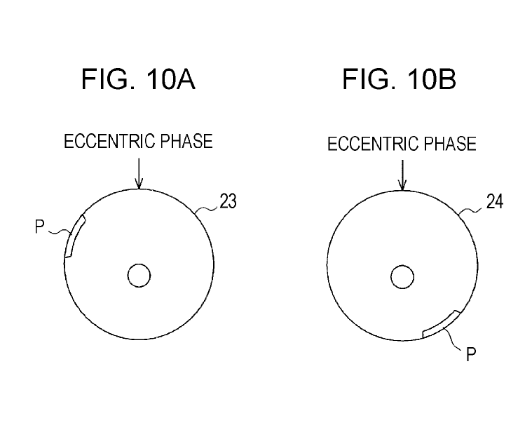

FIG. 9A shows an example of the result of detecting the eccentric amount of the driving roller 23. The detected result is detected and stored in association with a relationship between the number of motor steps and the eccentric amount, by resetting the number of motor steps of the driving motor 32 to the reference phase pulse from the reference phase detection sensor 9 for the driving roller and rotating the driving roller 23 two revolutions therefrom. FIG. 9B shows an example of the result of detecting the eccentric amount of the driven roller 24. The detected result is detected and stored in association with a relationship between the number of encoder pulses and the eccentric amount, by resetting the number of encoder pulses of the rotary encoder sensor 31 to the reference phase pulse from the reference phase detection sensor 10 for the driven roller and rotating the driven roller 24 two revolutions therefrom. In these results, a phase which has a peak eccentric amount after the reference phase signal is denoted by a vertical line as the eccentric direction, that is, the eccentric phase. In these examples, for example, as shown in FIG. 10, the eccentric phase and the reference position signal, that is, the reflection pattern P, are deviated from each other. The eccentric amounts of the driving roller 23 and the driven roller 24 are restored whenever the rollers make one revolution.

Accordingly, with respect to the driving roller 23, when the driving roller 23 is rotated by the driving motor 32 by the number of steps from the detection of the reference phase signal for the driving roller to the eccentric phase, the eccentric phase of the driving roller 23 may be set to the position of the reference phase detection sensor 9 for the driving roller. With respect to the driven roller 24, when the driven roller 24 is rotated by the driving motor 32, the driving roller 23 and the transporting belt 22 by the number of encoder pulses from the detection of the reference phase signal for the driven roller to the eccentric phase, the eccentric phase of the driven roller 24 may be set to the position of the reference phase detection sensor 10 for the driven roller. Accordingly, the eccentric phase of the driving roller 23 may be matched to that of the driven roller 24. Actually, the eccentric phase of the driven roller 24 is first matched, the driven roller 24 is fastened to the fastening shaft 33 through the clutch 11, the solenoid 13 is turned off so as to remove the tension of the transporting belt 22, and the eccentric phase of the driving roller 23 is matched.

The matching of the eccentric phase of the driving roller 23 and the driven roller 24 prevents the expansion and contraction of the transporting belt 22 as described above and is efficient as a method of preventing unevenness of the printed image. Meanwhile, although the eccentric phases of the driving roller 23 is matched to that of the driven roller 24, if the circumferential lengths of the both rollers are different from each other, the eccentric phases thereof are deviated from each other as the rollers 23 and 24 rotate. However, for example, if the eccentric phases are matched to each other whenever one page of a printing medium 1 is printed, it is impossible to cope with high-speed printing required in the line head type ink jet printer according to the present embodiment. Accordingly, in the present embodiment, numbers of rotations (the numbers of times of rotations) are set such that a maximum value of a variation in distance between the rollers accumulated whenever the driving roller 23 and the driven roller 24 are rotated is equal to or less than a predetermined value and the eccentric phases are matched to each other, that is, calibration is performed when the both rotation numbers become a predetermined rotation number.

The eccentric amount d₁ of the driving roller 23 is expressed by Equation 1 using an eccentric amplitude H₁ of the driving roller 23, the total number T₁ (=1440) of steps of the driving motor 32 corresponding to one revolution of the driving roller 23, and the number t₁ of steps of the driving motor 32 from the reference phase signal for driving roller.

d₁=H₁×cos(2π×t₁/T₁) Equation 1

Similarly, the eccentric amount d₂ of the driven roller 24 is expressed by Equation 2 using an eccentric amplitude H₂ of the driven roller 24, the total number T₂ (=1440) of rotary encoder pulses output at the time of one revolution of the driven roller 24, and the number t₂ of encoder pulses from the reference phase signal for driven roller.

d₂=H₂×cos(2π×t₂/T₂) Equation 2

The distance d between the rollers is a composed function of the eccentric amount d₁ of the driving roller 23 and the eccentric amount d₂ of the driven roller 24, but a phase difference Φ therebetween is not actually considered. The phase difference Φ is a value obtained by accumulating the rotation number of a rotation angle difference φ corresponding to the difference between the circumferential lengths of the driving roller 23 and the driven roller 24. Using this, Equation 2 is converted into Equation 3 and a variation Δd in the distance d between the rollers expressed by the sum with the eccentric amount d₁ of the driving roller 23 of Equation 1 is obtained and a predetermined calibration rotation number n is solved such that the maximum thereof becomes equal to or less than a predetermined value Δd₀.

$$\begin{matrix}Equation 3 & \\ \begin{matrix}{d}_{2} = {H}_{2} \times cos ( 2 π \times {t}_{2} / {T}_{2} + φ ) \\ = {H}_{2} \times cos ( 2 π \times {t}_{2} / {T}_{2} + {\sum }_{n = 0}^{n} n φ )\end{matrix} & ( 3 )\end{matrix}$$

The rotation angle difference φ corresponding to the difference between the circumferential lengths of the driving roller 23 and the driven roller 24 is obtained as described below. In the present embodiment, 1440 rotary encoder pulses are output while the driven roller 24 makes one revolution. For example, if the rotary encoder pulse number is 14390 when the driving roller 23 accurately makes ten revolutions by controlling the number of steps of the driving motor 32, it is smaller than the rotary encoder pulse number, which should be originally obtained, by 10 pulses. That is, since the number of rotations of the driven roller 24 is reduced by one pulse in the rotary encoder pulse number with respect to one revolution of the driving roller 23, the rotation angle difference φ corresponding to the difference between the circumferential lengths becomes −360°/1440=−0.25°. As the result of continuously measuring the distance d between the driving roller 23 and the driven roller 24 after the calibration, if the distance d between the rollers exceeds the predetermined value d₀ when the both phases are deviated from each other by 60°, a value obtained by dividing the phase difference Φ=60° by the rotation angle difference φ=0.25φ corresponding to the difference between the circumferential lengths, that is, 240 rotations, may be the predetermined calibration rotation number n.

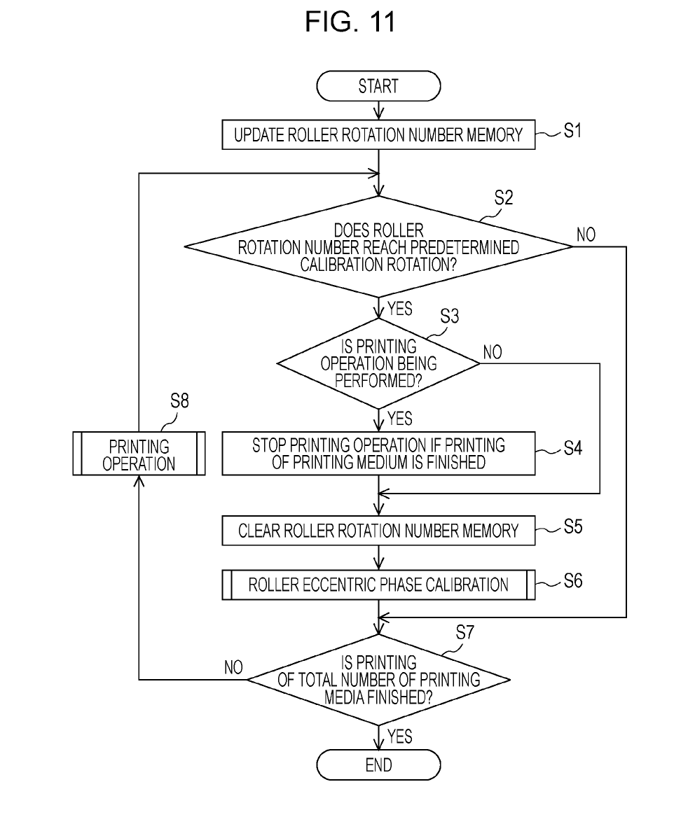

FIG. 11 is a flowchart showing a computing process for the calibration of the eccentric phases of the rollers based on the above principle. This computing process is performed according to a printing command. In this computing process, first, in a step S1, a roller rotation number memory is updated.

Next, the process progresses to a step S2, in which it is determined whether or not the roller rotation number of the updated roller rotation number memory reaches the predetermined calibration rotation number. If it is determined that the roller rotation number reaches the predetermined calibration rotation number, the process progresses to a step S3. If so not, the process progresses to a step S7.

In the step S3, it is determined whether or not the printing operation is being performed. If it is determined that the printing operation is being performed, the process progresses to a step S4. If so not, the process progresses to a step S5.

In the step S4, if the printing operation of the printing medium is finished, the printing operation is stopped and then the process progresses to a step S5.

In the step S5, the roller rotation number memory is cleared and then the process progresses to a step S6.

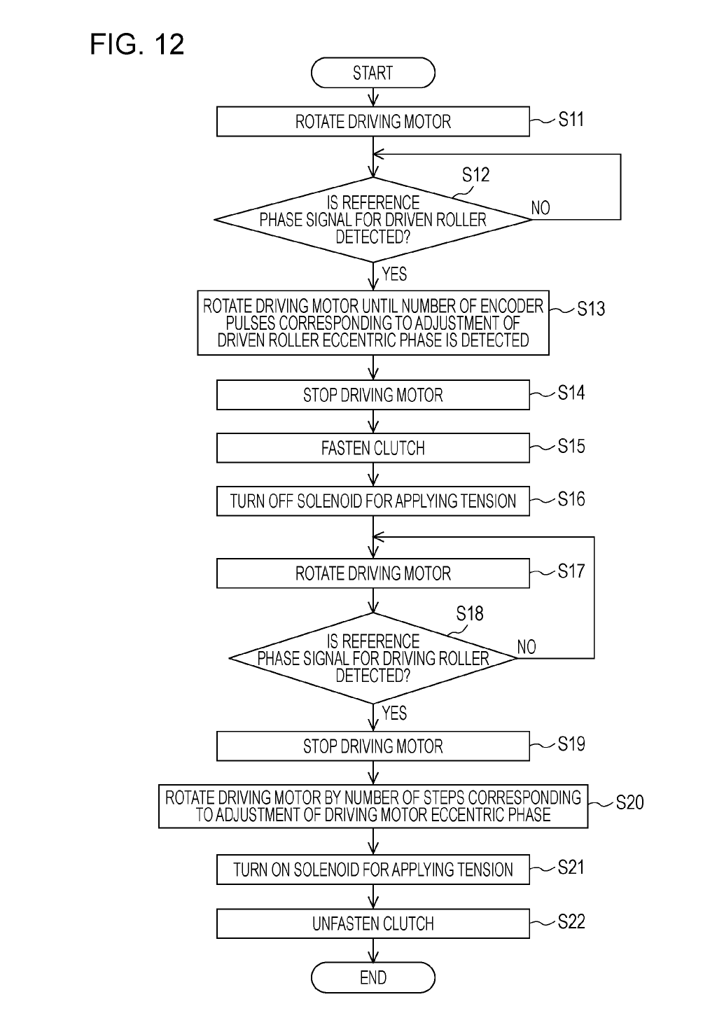

In the step S6, a roller eccentric phase calibration is performed by a computing process shown in FIG. 12 and then the process progresses to a step S7.

In the step S7, it is determined whether or not the printing of total number of printing media is finished. If it is determined that the printing of the total number of printing media is finished, the process returns to a main program. If so not, the process progresses to a step S8.

In the step S8, the printing operation is performed by a separate computing process (not shown) and the process progresses to the step S2.

Next, the computing process shown in FIG. 12 which is performed in the step S6 of the computing process shown in FIG. 11 will be described. In this computing process, first, in a step S11, the driving motor 32 is rotated.

Next, the process progresses to a step S12, in which it is determined whether or not the reference phase signal for the driven roller is detected. If it is determined that the reference phase signal for the driven roller is detected, the process progresses to a step S13. If so not, the process stands by.

In the step S13, the driving motor 32 is rotated until the number of encoder pulses corresponding to the adjustment of the eccentric phase of the driven roller 24 is detected.

Next, the process progresses to a step S14, in which the driving motor 32 is stopped.

Next, the process progresses to a step S15, in which the clutch 11 is fastened such that the driven roller 24 is fastened to the fastening shaft 33.

Next, the process progresses to a step S16, in which the solenoid 13 for applying the tension is turned off so as to remove the tension of the transporting belt 22.

Next, the process progresses to a step S17, in which the driving motor 32 is rotated.

Next, the process progresses to a step S18, in which it is determined whether or not the reference phase signal for the driving roller is detected. If it is determined that the reference phase signal for the driving roller is detected, the process progresses to a step S19. If so not, the process progresses to a step S17.

In the step S19, the driving motor 32 is stopped.

Next, the process progresses to a step S20, in which the driving motor 32 is rotated by the number of steps corresponding to the adjustment of the eccentric phase of the driving roller 23.

Next, the process progresses to a step S21, in which the solenoid 13 for applying the tension is turned on such that the tension is applied to the transporting belt 22.

Next, the process progresses to a step S22, in which the clutch 11 is unfastened such that the driven roller 24 is unfastened from the fastening shaft 33. Then, the process returns to the main program.

According to the computing processes, the roller rotation number memory is updated whenever the printing command is given and the roller eccentric phase calibration is performed if the roller rotation number memory reaches the predetermined calibration rotation number. In the roller eccentric phase calibration, first, the reference phase signal for the driven roller is detected, the driven motor 32 is rotated until the number of encoder pulses corresponding to the adjustment of the eccentric phase of the driven roller is detected, and the calibration of the eccentric phase of the driven roller 24 is performed. If the calibration of the eccentric phase of the driven roller 24 is finished, the clutch 11 is fastened such that the driven roller 24 is fastened to the fastening shaft 33, the solenoid 13 is turned off to remove the tension of the transporting belt 22, and the driven roller 24 is detached from the transporting roller 22 or the driving roller 23. If the detachment of the driven roller 24 is finished, the reference phase signal for the driving roller is detected, the driving motor 32 is rotated by the number of steps corresponding to the adjustment of the eccentric amount of the driving roller, and the calibration of the eccentric phase of the driving roller 23 is performed. If the calibration of the eccentric phase of the driving roller 23 is finished, the solenoid 13 is turned on, the tension is applied to the transporting belt 22, and the clutch 11 is unfastened so as to unfasten the driven roller 24.

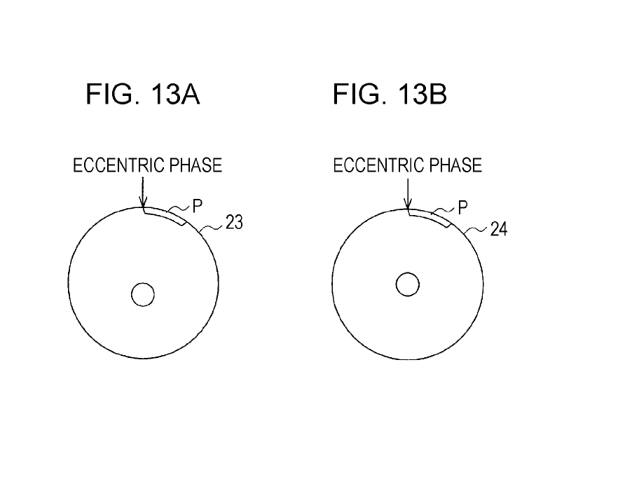

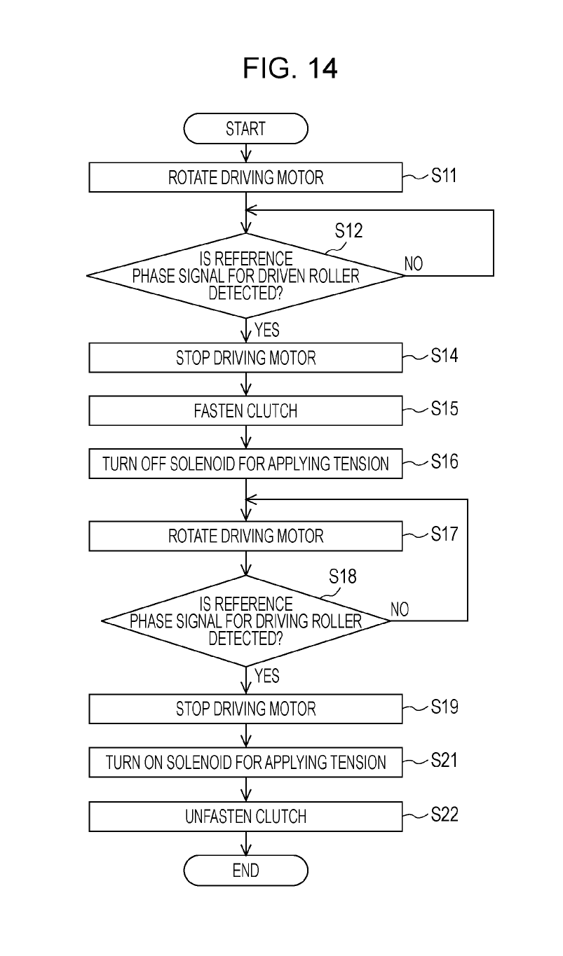

Although the eccentric phase calibration when the eccentric phases of the driving roller 23 and the driven roller 24 and the reference position signal, that is, the reflection pattern P, are deviated from each other is described, the eccentric phases of the driving roller 23 and the driven roller 24 and the reference position signal, that is, the reflection pattern P, may not be deviated from each other, as shown in FIGS. 13A and 13B. In this case, a computing process shown in FIG. 14 is performed instead of the computing process shown in FIG. 12. The computing process shown in FIG. 14 is obtained by deleting the step S13 and the step S20 of the computing process shown in FIG. 12. In more detail, the driving motor 32 is stopped at a time point when the reference phase signal for the driven roller is detected, the driven roller 24 is detached from the transporting belt 22 or the driving roller 23, the reference phase signal for the driving roller is detected in this state, the driving motor 32 is stopped at a time point when the reference phase signal for the driving roller is detected, and the driven roller 24 is connected to the transporting belt 22 or the driving roller 23 in this state.

According to the ink jet printer of the present embodiment, in the ink jet printer in which the transporting belt 22 is wound on the driving roller 23 and the driven roller 24 and the ink droplets are discharged from the ink jet heads 20 onto the printing medium 1 transported by the transporting belt 22, if the number of rotations of the rollers 23 and 24 becomes the predetermined calibration rotation number, the eccentric phase of the driving roller 23 is matched to that of the driven roller 24. Accordingly, it is possible to simultaneously realize the high-speed printing and the prevention of the unevenness of the printed image.

It is possible to prevent the unevenness of the printed image with certainty, by setting the predetermined calibration rotation number such that the maximum value of the variation Δd in the distance d between the driving roller 23 and the driven roller 24 is equal to or less than the predetermined value Δd₀.

In a case where the reference phases of the rollers 23 and 24 are matched to the phases (eccentric phases) corresponding to the eccentric directions of the roller 23 and 24, the eccentric phase of the rollers 23 and 24 are matched to each other by setting the reference phases of the rollers 23 and 24 to the predetermined phases. Accordingly, it is possible to match the eccentric phases of the rollers 23 and 24 each other with certainty.

In a case where the reference phases of the rollers 23 and 24 are not matched to the phases (eccentric phases) corresponding to the eccentric directions of the roller 23 and 24, the phase differences between the reference phases of the rollers 23 and 24 and the phases (eccentric phases) corresponding to the eccentric directions of the rollers 23 and 24 are previously stored, the reference phases of the rollers 23 and 24 are set to the predetermined phases, and the rollers 23 and 24 are rotated by the phase difference, thereby matching the eccentric phases of the rollers 23 and 24 to each other. Accordingly, it is possible to match the eccentric phases of the rollers 23 and 24 each other with certainty.

Since the rotation by the phase difference is controlled by the number of steps of the step motor (driving motor) 32 for driving the driving roller 23, it is possible to easily control the rotation by the phase difference of the driving roller 23 with certainty.

Since the rotation by the phase difference is controlled by the number of input pulses of the rotary encoder provided in the driven roller 24, it is possible to easily control the rotation by the phase difference of the driving roller 24 with certainty.

Since the solenoid 13 (belt tension removing device) for independently adjusting the phases of the two rollers 23 and 24 is included, it is possible to easily match the eccentric phases of the two rollers 23 and 24.

Since the clutch 11 (friction device) for restricting the rotation of the driven roller 24 is included, the phase of the driving roller 23 can be controlled in a state in which the rotation of the driven roller 24 is restricted by the clutch 11 (friction device) and the eccentric phases of the two rollers 23 and 24 are easily matched to each other.

The ink jet printer according to the invention is applicable to every type of ink jet printer in which a transporting belt is wound on at least two rollers so as to transport a printing medium and ink droplets are discharged from the ink jet printer onto the transported printing medium.

What is claimed is:

1. An ink jet printer comprising:
a pair of rollers;
a transporting belt wound on the pair of rollers;
ink jet heads which discharge ink droplets onto a printing medium transported by the transporting belt;
a calibrator which matches eccentric phases of the pair of rollers to each other; and
a calibration control unit which matches the eccentric phases of the rollers to each other by the calibrator if the numbers of rotations of the rollers become a predetermined calibration rotation number.

2. The ink jet printer according to claim 1, wherein the predetermined calibration rotation number is set such that a maximum variation in distance between the rollers is equal to or less than a predetermined value.

3. The ink jet printer according to claim 1, further comprising reference phase detection units which respectively detect reference phases of the rollers,
wherein the calibration control unit sets reference phases of the rollers detected by the reference phase detection units to predetermined phases if the reference phases of the rollers are matched to the phases corresponding to eccentric directions of the rollers.

4. The ink jet printer according to claim 3, wherein the calibration control unit previously stores a phase difference between the reference phases of the rollers and the phases corresponding to the eccentric direction of the rollers, sets the reference phases of the rollers detected by the reference phase detection units to predetermined phases, and rotates the rollers by the phase difference so as to match the eccentric phases of the roller to each other, if the reference phases of the rollers are not matched to the phases corresponding to eccentric directions of the rollers.

5. The ink jet printer according to claim 4, wherein, if any one of the rollers is a driving roller, the calibration control unit controls rotation by the phase difference by the number of steps of a step motor for driving the driving roller.

6. The ink jet printer according to claim 4, wherein, if any one of the rollers is a driven roller, the calibration control unit controls rotation by the phase difference by the number of input pulses of a rotary encoder provided in the driven roller.

7. The ink jet printer according to claim 1, further comprising a belt tension removing unit which independently adjusting the phases of the rollers.

8. The ink jet printer according to claim 1, further comprising a friction unit which restricts rotation of a driven roller, if any one of the rollers is the driven roller.
